(19) United States
(12) Patent Application Publication
(10) Pub. No.: US 2022/0040952 A1
(43) Pub. Date: Feb. 10, 2022

(54) TUBULAR BAG MACHINE FOR PRODUCING PAPER BAGS

(71) Applicant: Syntegon Technology GmbH, Waiblingen (DE)

(72) Inventor: Ulrich Wieduwilt, Schwaebisch Gmuend (DE)

(21) Appl. No.: 17/433,632

(22) PCT Filed: Feb. 26, 2020
(86) PCT No.: PCT/EP2020/054961

§ 371 Date: Aug. 25, 2021

(30) Foreign Application Priority Data
Mar. 1, 2019 (DE) 10 2019 202 847.0

(51) Int. Cl. B31B 70/64; B31B 70/74; B31F 5/00

(52) U.S. Cl. CPC B31B 70/644; B31B 2155/0014; B31F 5/008; B31B 70/76

(57) ABSTRACT

The present invention relates to a tubular bag machine for producing tubular bag packaging materials from paper, comprising a draw-off station (2) for drawing off a paper web (10), a roughening station (3) for the continuous roughening of at least one joining region of the paper web (10), a moistening station (4) for moistening at least one joining region of the paper web (10), a forming station (5) for forming a bag tube, and an ultrasonic sealing station (6) for sealing the joining region of the paper web (10).

### BACKGROUND

The present invention relates to a tubular bag machine for producing tubular bags made of paper, wherein the tubular bags can be produced without any additional adhesive or thermoplastic synthetic resin or the like and are thus completely recyclable.

EP 0 340 334 A2 discloses a device which joins paper products by means of ultrasound. Here, the paper used has a thermoplastic coating. This thermoplastic coating is partly melted during the joining operation. Following cooling and curing, the joining regions of the paper layers are then connected to one another. Furthermore, DE 10 2013 225 745 A1 discloses an ultrasound joining method for connecting paper material, in which ultrasonic friction welding is carried out. Although these known methods have in principle been tried and tested, there is an urgent need, in particular because of tightened environmental regulations, that, for example, packaging materials are produced completely from paper material which is recyclable and contains no further additional contents, in particular plastics or adhesives or the like, from which environmental pollution can result.

### SUMMARY

By contrast, the tubular bag machine according to the invention has the advantage that tubular bags can be produced from a continuous paper web without additional adhesive being needed or the paper web being coated with, for example, a thermoplastic or the like. According to the invention, the tubular bags can be produced from untreated paper.

As a result, it is possible to provide completely recyclable packaging materials for goods, in particular foods or the like. In addition, the production-based advantage additionally results that no kind of adhesive or coated paper or the like has to be used, which would unnecessarily make the production more expensive. Furthermore, it is possible to ensure that since no adhesive or the like is used, a cleaning process of the tubular bag machine can be carried out very simply and safely.

According to the invention, this is achieved in that the tubular bag machine comprises a draw-off station for drawing off the paper web, a roughening station for roughening at least one joining region on the paper web and a moistening station for moistening at least one joining region on the paper web. Also provided is a forming station for forming a bag tube, and an ultrasound sealing station for sealing the joining region. Thus, according to the invention, the paper web is drawn off and roughened in the joining region in the roughening station. If, for example, a longitudinal sealing operation of the bag tube is to be performed, the roughening is carried out on one edge of the paper web. The roughened joining region is then moistened in the moistening station. Here, it should be noted that the order can also be reversed, i.e. that the joining region is moistened first and then roughened in the roughening station. In the forming station, a bag tube is then formed in a known way, for example over a forming shoulder or a forming shoe, and a longitudinal seam is sealed with ultrasound in the ultrasonic sealing station. Here, as a result of roughening and moistening the joining region of the paper, no additional adhesive or the like is necessary. In addition, no coating of the paper, for example with thermoplastic, has to be provided. As a result of the roughening, the surface of the joining region is enlarged. The moistening before the ultrasonic sealing operation ensures that there is moisture in the roughened joining region, so that hydrogen bridges between the joining regions are also produced in the sealing step and, thus, a joining seam with a high tightness and strength is achieved without additional sealing medium. Here, the result of trials shows that the seam produced on the paper bags is very firm and, under the external action of force, the seam lasts longer than the actual paper packaging material, i.e. that the bag tears before the seam tears.

The sub claims show preferred developments of the invention.

The ultrasonic sealing station is preferably an ultrasonic friction welding sealing station. Here, the sealing operation is carried out by means of friction welding and not, as is usual in the prior art, by means of percussive ultrasonic movement. Here, more heat can be introduced into the joining region by the friction welding operation, which means that the sealing operation can be carried out in a shorter time and, in particular, the moisture introduced before the sealing step can be substantially completely removed.

A particularly simple construction of the ultrasonic sealing station is achieved if the ultrasonic sealing station has a sonotrode and an anvil, wherein a movement direction of the sonotrode and that of the anvil relative to each other is not parallel. The anvil is preferably a rotary anvil and rotates about an axis. As a result, a continuous joining operation can be carried out in the friction welding sealing station. The direction of movement of the sonotrode is preferably parallel to the mid-axis of the rotary anvil and, in particular, perpendicular to the direction of the force of the rotary anvil.

More preferably, in the passage direction of the paper web through the tubular bag machine, the roughening station is arranged upstream of the moistening station. Thus, firstly roughening of the joining region and then moistening take place. As a result of the enlargement of the surface of the joining region by the roughening step, more moisture can thus be absorbed in the joining region.

According to a further preferred embodiment of the invention, the moistening station is set up in such a way that only the roughened joining region is moistened. This avoids other regions of the paper web being moistened, which could lead to tearing of the paper as the paper web runs through the tubular bag machine.

Preferably, a surface pressure in the ultrasonic sealing station is in a range from 20 to 50 MPa, in particular 30 to 40 MPa. More preferably, the surface pressure is adjustable, in particular as a function of a paper thickness.

The ultrasonic sealing station is preferably a longitudinal sealing station. Preferably, the ultrasonic sealing station additionally further comprises a transverse sealing station. Here, to produce the longitudinal seam and the transverse seam, the sealing method according to the invention is preferably carried out with preceding roughening and moistening and subsequent friction welding sealing by means of ultrasound.

### BRIEF DESCRIPTION OF THE DRAWINGS

In the following, a preferred exemplary embodiment of the invention will be described in detail with reference to the accompanying drawing, in which:

FIG. 1 is a schematic illustration of a tubular bag machine according to a preferred exemplary embodiment of the invention, and

FIG. 2 is a schematic perspective illustration of an ultrasonic sealing station from FIG. 1.

### DETAILED DESCRIPTION

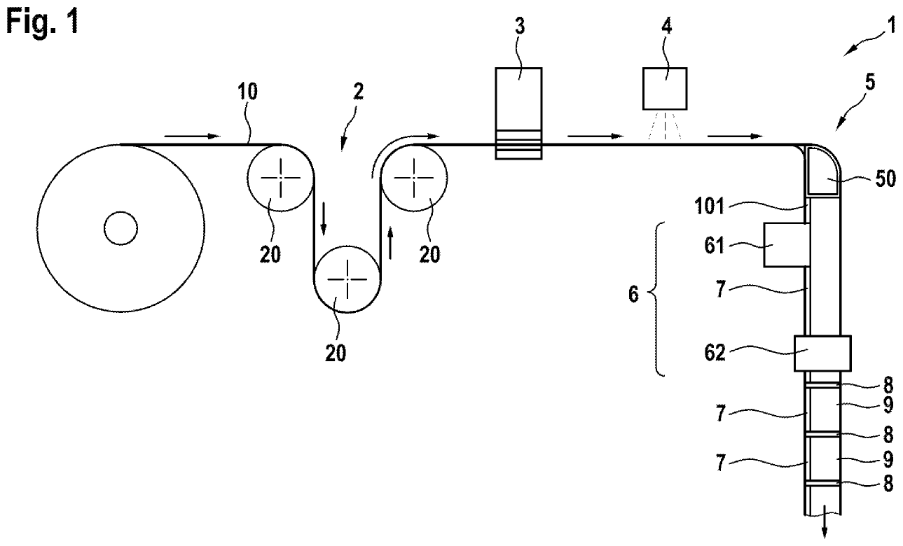

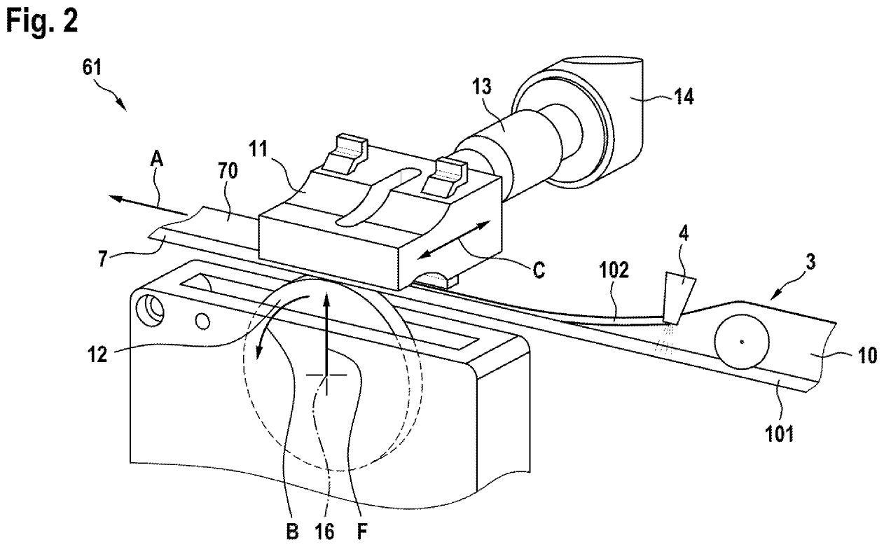

A tubular bag machine 1 according to a preferred exemplary embodiment of the invention will be described in detail below with reference to FIGS. 1 and 2.

FIG. 1 gives, schematically, an overview of the tubular bag machine 1 according to the invention. The tubular bag machine 1 comprises a draw-off station 2, at which a paper web 10 is drawn off a large roll by means of a draw-off device in the form of driven rollers 20.

The paper web 10 is then fed to a roughening station 3, in which a joining region 101 on the paper web is roughened. In this exemplary embodiment, the roughening station 2 here roughens an edge region on a longitudinal side of the paper web, in order later to seal a longitudinal seam 7 and in addition also to seal transverse regions at right angles to the edge region in order to seal a transverse seam 8. Here, continuous roughening is carried out on the long-side joining region. The transverse regions are roughened section by section in accordance with the bag size.

In a next step, the paper web 10 provided with the roughened joining regions is fed to a moistening station 4. In the moistening station 4, the roughened joining regions are moistened. Here, it should be noted that only exactly the joining region 101 is moistened and not the remaining, non-roughened, paper web, in order to avoid tearing during the onward transport of the paper web.

In the next step, the paper web 10 is fed to a forming station 5 having a forming shoulder 50, at which a bag tube is formed.

Then, the not yet sealed bag tube is fed to an ultrasonic sealing station 6.

As can be seen from FIG. 1, the ultrasonic sealing station 6 comprises a longitudinal sealing station 61 and a transverse sealing station 62. In the direction of movement of the paper web 10, the transverse sealing station 62 is arranged downstream of the longitudinal sealing station 61.

In the longitudinal sealing station 61, the roughened and moistened joining region 101 at the edge is sealed to form a longitudinal seam 7. This produces a closed tubular bag 70. The latter is then fed to the transverse sealing station 62, in which a transverse seam 8 at right angles to the longitudinal seam 7 is sealed. Here, in a known manner, the transverse seam 8 forms both a bottom seam and also a top seam of a tubular bag 9. Filling via the forming shoulder or a filling and forming pipe can then be carried out and the paper web can be guided onward by a step in order to seal the next transverse seam 8.

The longitudinal sealing station 61 can be seen in detail from FIG. 2.

The longitudinal sealing station 61 comprises a sonotrode 11, a rotary anvil 12, a converter 13 and an ultrasound generator 14. As can be seen from FIG. 2, the rotary anvil 12 rotates about an axis 16 in the conveying direction A of the paper web 10, which is indicated in FIG. 2 by the arrow B. The ultrasonic sonotrode 11 is moved back and forth at right angles to the direction of movement A, which is indicated in FIG. 2 by the double arrow C.

The rotary anvil 12 further provides a joining force in the direction of the arrow F, which is likewise at right angles to the direction of movement C of the sonotrode 11. As a result of this configuration, friction welding on the joining region of the paper web 10 is possible, by which means a high input of heat into the joining region is achieved. Since the surface of the joining region is enlarged by the roughening of the joining region, a greater amount of moisture can be introduced into the joining region in the moistening step. As a result, reinforcing hydrogen bonds in the joining region can be achieved in the ultrasonic sealing station by the friction welding operation.

In FIG. 2, the paper web 10 is illustrated only schematically, in this exemplary embodiment only one joining region 101 on the edge region of the paper web 10 having been processed by means of roughening and moistening. The second edge region of the paper web 10, which is the second joining region 102 and is joined together with the processed joining region in the ultrasonic sealing station 6, is unprocessed.

Thus, a tubular bag 70 can be produced from paper, no additional glue being needed for the sealing operation and no thermoplastic coating or the like or a thermoplastic film having to be introduced into the joining region either. The connection between the joining regions of the paper web 10 can be achieved exclusively by the ultrasonic joining operation of the roughened and moistened joining region.

It should be noted that the tubular bag machine 1 can, for example, also be constructed in such a way that only the first joining region 101 on the edge region of the paper web 10 is roughened, and the second joining region 102 on the opposite edge region of the paper web 10 is only moistened, and the two joining regions are then joined together in the ultrasonic sealing station 6. As a further alternative, both the first and the second joining region can both each be roughened and moistened. Furthermore, it would also be conceivable that both joining regions are roughened and only one joining region is then moistened. Furthermore, it is also possible that moistening of the joining region is carried out first and only then is the roughening carried out, wherein reduced forces have to be used in the roughening operation, in order to avoid tearing of the moistened joining region.

1. Tubular bag machine for producing tubular bag packaging materials from paper, comprising:
a draw-off station (2) for drawing off a paper web (10),
a roughening station (3) for the continuous roughening of at least one joining region of the paper web (10),
a moistening station (4) for moistening at least one joining region of the paper web (10),
a forming station (5) for forming a bag tube, and
an ultrasonic sealing station (6) for sealing the joining region of the paper web (10).

2. Tubular bag machine according to claim 1, wherein the ultrasonic sealing station (6) is an ultrasonic friction welding sealing station and carries out a joining operation by means of friction welding.

3. Tubular bag machine according to claim 2, wherein the ultrasonic friction welding sealing station has a sonotrode (11) and an anvil (12), wherein the joining region is guided between the sonotrode and anvil and wherein a direction of movement of the sonotrode and anvil is not parallel.

4. Tubular bag machine according to claim 3, wherein the anvil is a rotary anvil and in particular rotates in the direction of movement (A) of the paper web (10).

5. Tubular bag machine according to claim 1, wherein, in the direction of movement (A) of the paper web (10), the roughening station (3) is arranged upstream of the moistening station (4).

6. Tubular bag machine according to claim 1, wherein the moistening station (4) is set up to moisten only the roughened joining region on the paper web (10).

7. Tubular bag machine according to claim 1, wherein the ultrasonic sealing station (6) provides a surface pressure in a range from 20 to 50 MPa, in particular 30 to 40 MPa, during the sealing operation.

8. Tubular bag machine according to claim 1, wherein the ultrasonic sealing station (6) comprises a longitudinal sealing station (61) and/or a transverse sealing station (62).
